(19) United States
(12) Patent Application Publication
(10) Pub. No.: US 2014/0184568 A1
(43) Pub. Date: Jul. 3, 2014

(54) DISPLAY DEVICE INCLUDING SENSING UNIT AND METHOD OF DRIVING THE DISPLAY DEVICE

(71) Applicant: Samsung Display Co., Ltd., Gyeonggi-do (KR)

(72) Inventors: Hee Joon KIM, Yongin-si (KR); Jae Sung Kong, Daegu (KR); Jeong Woon Lee, Chungcheongnam-do (KR)

(73) Assignee: SAMSUNG DISPLAY CO., LTD., Gyeonggi-do (KR)

(21) Appl. No.: 13/893,965

(22) Filed: May 14, 2013

(30) Foreign Application Priority Data
Dec. 31, 2012 (KR) 10-2012-0158264

(51) Int. Cl. G06F 3/042

(52) U.S. Cl. CPC G06F 3/042
USPC 345/175

(57) ABSTRACT

A method of driving a display device is provided. The display device includes a plurality of sensing unit groups arranged in a matrix form. Each of the plurality of sensing unit groups includes a plurality of sensing units and a sensing signal processing unit. The method includes applying scanning signals to a plurality of scanning signal lines respectively connected to the plurality of sensing units of a first sensing unit group among the plurality of sensing unit groups. Sensing signals are generated and outputed to at least one sensing signal line by a plurality of sensing units respectively receiving the scanning signals. The scanning signals are applied to two or more sensing units among the plurality of sensing units of the first sensing unit group in a first touch mode. The scanning signals are synchronized with each other.

### CROSS-REFERENCE TO RELATED APPLICATION

This U.S. non-provisional application claims priority under 35 U.S.C. §119 to Korean Patent Application No. 10-2012-0158264 filed in the Korean Intellectual Property Office on Dec. 31, 2012, the disclosure of which are incorporated by reference herein in its entirety.

### TECHNICAL FIELD

Exemplary embodiments of the present invention relate to displays, and more specifically, to a display device including a sensing unit and a method of driving the display device.

### DISCUSSION OF THE RELATED ART

Various types of flat panel displays may have a touch sensing function or an image sensing function.

A flat panel display includes touch sensors embedded in the display panel. Each touch sensor may include a thin film transistor or a capacitor for sensing touch. When the display panel is touched, the touch sensors output sensing signals. Contact information, such as the position and intensity of the touch, may be obtained by analyzing the sensing signals.

Such touch sensors include light sensors that may sense changes in light irradiated thereto. There may be various types of light sensors that may sense light of various frequencies, such as infrared light and visible light. In a flat panel display, for example, a backlight, may be used as a light source that emits light necessary for sensing a touch by the light sensors.

The degree of sensitivity of touch sensors may be critical to obtain exact contact information.

### SUMMARY

An exemplary embodiment of the present invention provides a method of driving a display device. The display device includes a plurality of sensing unit groups arranged in a matrix form. Each of the plurality of sensing unit groups includes a plurality of sensing units. A sensing signal processing unit is included in the display device. The method includes applying scanning signals to a plurality of sensing units of a first sensing unit group among the plurality of sensing unit groups. Sensing signals are generated from the plurality of sensing units of the first sensing unit group and outputted to at least one sensing signal line. The scanning signals are applied to two or more sensing units among the plurality of sensing units of the first sensing unit group in a first touch mode. The scanning signals are synchronized with each other.

Scanning periods of the scanning signals applied to the plurality of sensing units of the first sensing unit group need not overlap each other in a second touch mode, which is different from the first touch mode.

The two or more sensing units may output the sensing signals to a common sensing signal line.

The output of the scanning signals of the first sensing unit group may be controlled by a plurality of different gate clock signals.

Each of the plurality of sensing units may include a switching element connected to a scanning signal line and the sensing signal line. A sensing element and a sensing capacitor are connected with the switching element. The sensing signal processing unit may include an integrator connected to the sensing signal line. A capacitor is connected between an output terminal and an input terminal of an integrator. The capacitor may be charged with the sensing signal for a sample hold time. An output terminal of the integrator may output a sensing output signal.

The sample hold time in the first touch mode may be different from the sample hold time in the second touch mode.

The sample hold time in the first touch mode may be substantially the same as the sample hold time in the second touch mode.

The method may further include converting the sensing output signal into a digital sensing signal. At least one value among a reference voltage used for the conversion or the digital sensing signal is adjusted in the second touch mode.

The method may further include radiating internal light to the plurality of sensing unit groups during a light irradiation period repeated at a cycle of one frame. A sensing signal is output by external light by resetting, at least two times during one frame, at least one sensing unit, except for the two or more sensing units, among the plurality of sensing units of the first sensing unit group.

The method may further include sequentially outputting the sensing signal alternately by the plurality of sensing units of the first sensing unit group in turn in the second touch mode.

An exemplary embodiment of the present invention provides a display device. The display device includes a plurality of sensing unit groups arranged in a matrix form. Each of the plurality of sensing unit groups includes a plurality of sensing units. A plurality of scanning signal lines are respectively connected with the plurality of sensing units of a first sensing unit group among the plurality of sensing unit groups. At least one sensing signal line is connected with the plurality of sensing units of the first sensing unit group. A scanning driver is configured to transmit scanning signals to the plurality of scanning signal lines, respectively. A sensing signal processing unit is configured to process a sensing signal transmitted by the sensing signal line. The scanning signals applied to two or more sensing units among the plurality of sensing units of the first sensing unit group in a first touch mode. The scanning signals are synchronized with each other.

Scanning periods of the scanning signals applied to the plurality of sensing units of the first sensing unit group need not overlap each other in a second touch mode, which is different from the first touch mode.

The two or more sensing units may be connected to substantially the same sensing signal line.

The scanning signals transmitted through the plurality of scanning signal lines may be output under the control of different gate clock signals.

The sensing unit may include a switching element connected to the scanning signal line and the sensing signal line. A sensing element and a sensing capacitor are connected with the switching element. The sensing signal processing unit may include an integrator connected to the sensing signal line. A capacitor is connected between an output terminal and an input terminal of the integrator. The capacitor may be charged with the sensing signal for a sample hold time, and the output terminal of the integrator may output a sensing output signal.

The sample hold time in the first touch mode may be different from the sample hold time in the second touch mode.

The sample hold time in the first touch mode may be substantially the same as the sample hold time in the second touch mode.

The sensing signal processing unit may further include an analog-digital (AD) converter. The AD converter is configured to convert the sensing output signal into a digital sensing signal. At least one value of a reference voltage of the AD converter or the digital sensing signal may be adjusted in the second touch mode.

The display device may further include a backlight. The backlight is configured to radiate internal light to the plurality of sensing unit groups during a light irradiation period repeated at a cycle of one frame. At least one sensing unit, except for the two or more sensing units, among the plurality of sensing units of the first sensing unit group may be reset at least two times during one frame to output a sensing signal by external light.

The plurality of sensing units of the first sensing unit group sequentially and alternately output the sensing signals in the second touch mode.

According to an exemplary embodiment of the present invention, a display device includes a first sensing unit and a second sensing unit positioned adjacent to the first sensing unit. A first scanning line is connected to the first sensing unit. A first scanning signal is applied through the first scanning line to the first sensing unit. A second scanning line is connected to the second sensing unit. A second scanning signal is applied through the second scanning line to the second sensing unit. A sensing line is jointly connected to the first sensing unit and the second sensing unit. In a first touch mode, the first scanning signal is synchronized with the second scanning signal.

### BRIEF DESCRIPTION OF THE DRAWINGS

The above and other features of the inventive concept will become more apparent by describing in detail exemplary embodiments thereof with reference to the accompanying drawings, in which:

FIGS. 1 and 2 are block diagrams illustrating a display device including a light sensor according to an exemplary embodiment of the present invention;

FIG. 3 is a circuit diagram illustrating a light sensor and a sensing signal processing unit according to an exemplary embodiment of the present invention;

FIGS. 4 and 5 are layout views illustrating a light sensor, which is operated in first and second touch modes, of a display device including the light sensor according to an exemplary embodiment of the present invention;

FIGS. 6, 7, 8, and 9 are timing diagrams illustrating a method of driving a display device including a light sensor according to an exemplary embodiment of the present invention;

FIG. 10 is a waveform diagram illustrating a sensing output signal according to a method of driving a display device including a light sensor according to an exemplary embodiment of the present invention;

FIG. 11 is a table showing touch sensitivities that may be obtained when a display device including a light sensor is in the first and second touch modes according to an exemplary embodiment of the present invention; and

FIG. 12 shows photographs illustrating sensitivities actually measured with respect to the four cases illustrated in FIG. 11.

### DETAILED DESCRIPTION OF EXEMPLARY EMBODIMENTS

Exemplary embodiments of the present invention will be described in more detail hereinafter with reference to the accompanying drawings. As those skilled in the art would realize, the described embodiments may be modified in various different ways.

Like reference numerals may designate like or similar elements throughout the specification and the drawings. It will be understood that when an element is referred to as being “on,” “connected to,” or “coupled to” another element, it can be directly on, connected to or coupled to the other element or intervening elements may be present.

As used herein, the singular forms “a,” “an,” and “the” are intended to include the plural forms as well, unless the context clearly indicates otherwise.

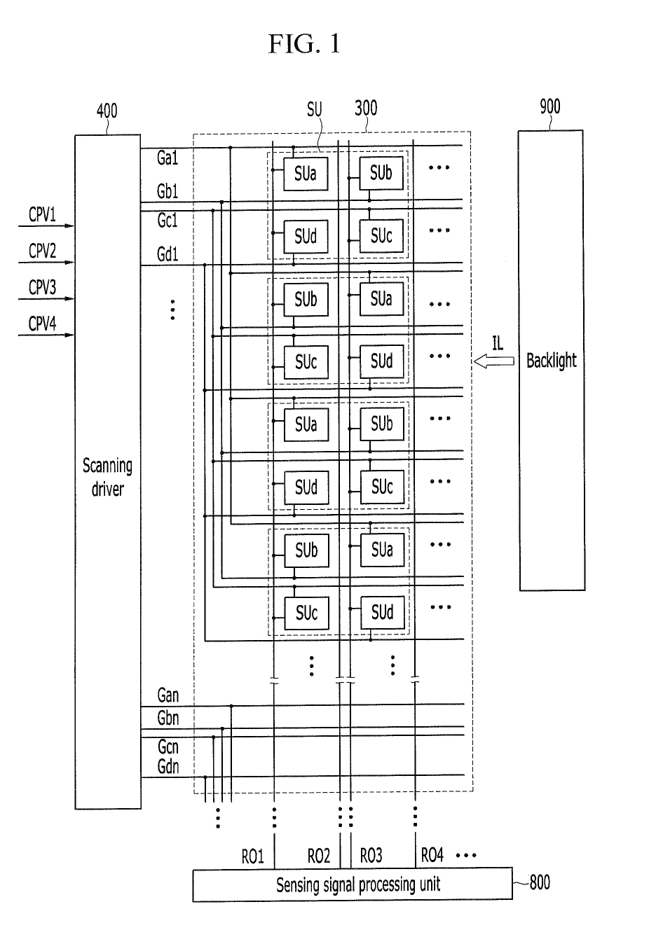

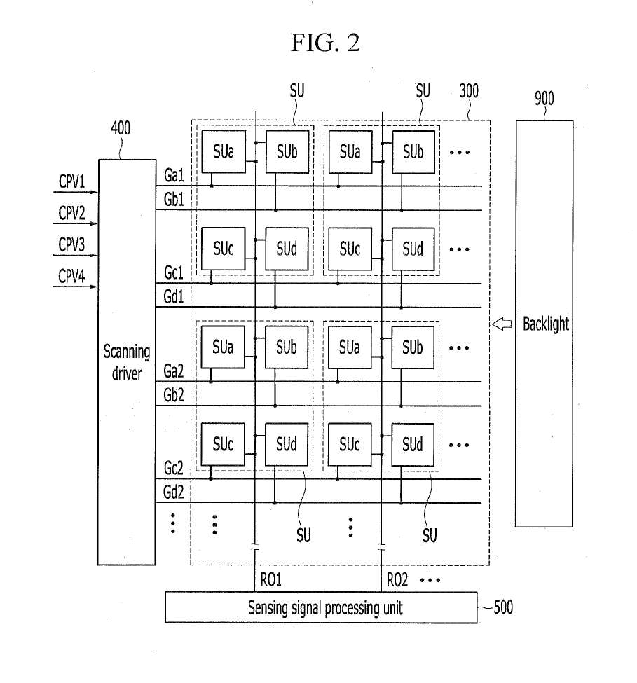

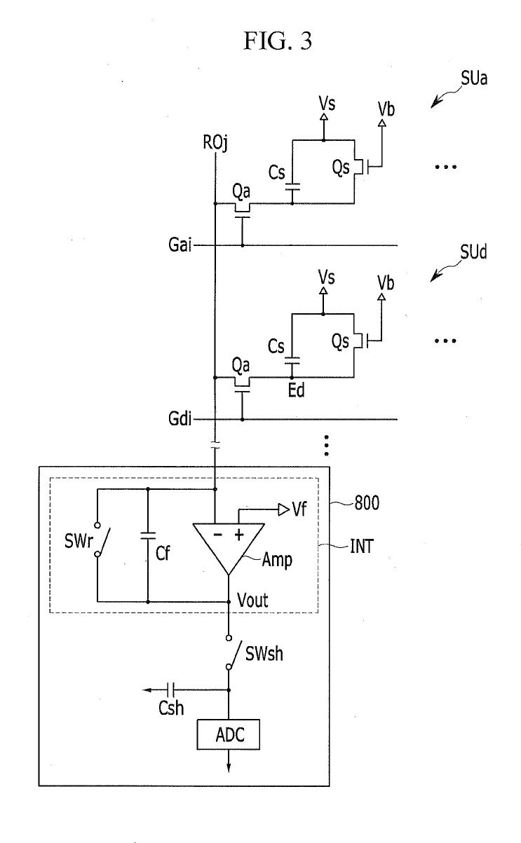

FIGS. 1 and 2 are block diagrams illustrating a display device including a light sensor according to an exemplary embodiment of the present invention, and FIG. 3 is a circuit diagram illustrating a light sensor and a sensing signal processing unit according to an exemplary embodiment of the present invention.

Referring to FIGS. 1 and 2, the display device according to the exemplary embodiment of the present invention has a light sensing function. The display device includes a display panel 300, a backlight 900, a scan driver 400, and a sensing signal processing unit 800.

The display panel 300 includes a plurality of signal lines, a plurality of pixels PX arranged substantially in a matrix pattern, and a plurality of sensing unit groups SU arranged substantially in a matrix pattern. When the display device according to an exemplary embodiment of the present invention is a liquid crystal display, the display panel 300 may include lower and upper display panels facing each other and a liquid crystal layer interposed between the lower and upper display panels.

The plurality of signal lines includes a plurality of image scanning signal lines and a plurality of image data lines connected with the plurality of pixels PX. The plurality of signal lines also include a plurality of scanning signal lines Ga1, Ga2, . . . , Gan, Gb1, Gb2, . . . , Gbn, Gc1, Gc2, . . . Gcn, and Gd1, Gd2, . . . , Gdn and a plurality of sensing signal lines RO1, RO2, . . . , and Rn (n is a positive integer) connected with the plurality of sensing unit groups SU.

Each image scanning signal line transmits a scan signal displaying an image, and each image data line transmits an image data signal.

The plurality of scanning signal lines Ga1 to Gan, Gb1 to Gbn, Gc1 to Gcn, and Gd1 to Gdn each may transmit a scan signal and may be extended substantially in a row direction. The plurality of scanning signal lines Ga1 to Gan, Gb1 to Gbn, Gc1 to Gcn, and Gd1 to Gdn may be divided into two or more scanning signal line groups that may independently and sequentially transmit scan signals, respectively. FIGS. 1 and 2 illustrate an example in which one display panel 300 includes four scanning signal line groups. The plurality of scanning signal lines Ga1 to Gan, Gb1 to Gbn, Gc1 to Gcn, and Gd1 to Gdn may include a first scanning signal line group Ga1 to Gan, a second scanning signal line group Gb1 to Gbn, a third scanning signal line group Gel to Gcn, and a fourth scanning signal line group Gd1 to Gdn. The scanning signal lines in the first scanning signal line group Ga1 to Gan, the scanning signal lines in the second scanning signal line group Gb1 to Gbn, the scanning signal lines in the third scanning signal line group Gc1 to Gcn, and the scanning signal lines in the fourth scanning signal line group Gd1 to Gdn may be alternately arranged.

Each of the first scanning signal line group Ga1 to Gan, the second scanning signal line group Gb1 to Gbn, the third scanning signal line group Gc1 to Gcn, and the fourth scanning signal line group Gd1 to Gdn may independently transmit a gate signal generated in the scan driver 400 under the control of separate gate clock signals CPV1, CPV2, CPV3, and CPV4. The gate clock signals CPV1, CPV2, CPV3, and CPV4 may control an output time of a gate-on pulse. Accordingly, since the first scanning signal line group Ga1 to Gan, the second scanning signal line group Gb1 to Gbn, the third scanning signal line group Gc1 to Gcn, and the fourth scanning signal line group Gd1 to Gdn each may independently transmit a gate-on voltage, the gate-on voltage may be transmitted substantially simultaneously or at different times by at least two scanning signal lines groups Ga1 to Gan, Gb1 to Gbn, Gc1 to Gcn, and Gd1 to Gdn.

The plurality of scanning signal lines Ga1 to Gdn included in each of the scanning signal line group Ga1 to Gan, Gb1 to Gbn, Gc1 to Gcn, and Gd1 to Gdn may sequentially output a gate-on voltage during a predetermined time period. The predetermined time period may be one horizontal cycle (1 H).

The plurality of sensing signal lines RO1, RO2, . . . may extend substantially in a column direction and may cross the plurality of scanning signal lines Ga1 to Gan, Gb1 to Gbn, Gc1 to Gcn, and Gd1 to Gdn. The sensing signal lines RO1, RO2, . . . each may receive a predetermined reference voltage Vf and may transmit sensing signals output from one of the plurality of sensing units SUa to SUd included in the sensing unit group SU.

Each sensing unit group SU includes, for example, four sensing units SUa, SUb, SUc, and SUd. Four sensing signal lines RO1, RO2, . . . may be disposed for each column of the sensing unit groups SU as illustrated in FIG. 1, or a sensing signal line may be disposed for each column of the sensing unit groups SU as illustrated in FIG. 2. Alternatively, two or three sensing signal lines RO, RO2, . . . may also be disposed for each column of the sensing unit groups SU.

A pixel PX may include at least one switching element connected to at least one image data line and at least one image scanning signal line, and at least one pixel electrode connected to the switching element. The switching element may include at least one thin film transistor. Each pixel PX may display a primary color, such as red R, green G, and blue B. A plurality of adjacent pixels respectively displaying different primary colors may form a dot.

One sensing group SU may be disposed for every one or more dots. For example, one sensing unit group SU may be disposed for every four adjacent dots.

One sensing unit group SU may include two or more sensing units SUa, SUb, SUc, and SUd. FIGS. 1 and 2 illustrate an example in which one sensing unit group SU includes four types of sensing units SUa to SUd. The sensing units SUa to SUd included in one sensing unit group SU may be arranged in a matrix pattern as illustrated in FIGS. 1 and 2.

The sensing units SUa to SUd may include light sensors for sensing a touch or approach of an external object or for sensing an image of an external object by using internal light IL generated in the backlight 900 to thereby generate sensing signals. For example, the sensing units SUa to SUd may sense a touch or an image of an external object by using infrared light or visible light.

Different types of sensing units SUa to SUd included in each sensing unit group SU may be independently driven to output sensing signals. A group of the sensing units SUa, a group of the sensing units SUb, a group of the sensing units SUc, and a group of the sensing units SUd, respectively, are connected to the different scanning signal line groups Ga1 to Gan, Gb1 to Gbn, Gc1 to Gcn, and Gd1 to Gdn. For example, the first sensing units SUa are connected to the first scanning signal line group Ga1 to Gan, the second sensing units SUb are connected to the second scanning signal line group Gb1 to Gbn, the third sensing units SUc are connected to the third scanning signal line group Gc1 to Gcn, and the fourth sensing units SUd are connected to the fourth scanning signal line group Gd1 to Gdn.

Referring to FIG. 2, substantially the same type of sensing units SUa to SUd positioned in different sensing unit groups SU from each other in the column direction may be connected to the different scanning signal lines Ga1 to Gan, Gb1 to Gbn, Gc1 to Gcn, and Gd1 to Gdn to thereby receive gate-on voltages at different times from each other. In this case, substantially the same type of sensing units SUa to SUd positioned in different sensing unit groups SU from each other may be connected to substantially the same sensing signal lines RO1, RO2, . . .

However, alternatively, substantially the same type of sensing units SUa to SUd in two or more sensing unit groups SU may be connected to substantially the same scanning signal line Ga1 to Gan, Gb1 to Gbn, Gc1 to Gcn, and Gd1 to Gdn as illustrated in FIG. 1 to thereby simultaneously receive a gate-on voltage. FIG. 1 illustrates an example in which substantially the same type of sensing units SUa to SUd of the four sensing unit groups SU adjacent in the column direction are connected to substantially the same scanning signal line Ga1 to Gan, Gb1 to Gbn, Gc1 to Gcn, and Gd1 to Gdn. In this case, substantially the same type of sensing units SUa to SUd connected to substantially the same scanning signal lines Ga1 to Gan, Gb1 to Gbn, Gc1 to Gcn, and Gd1 to Gdn are connected to the different sensing signal lines RO1, RO2, . . .

The arrangement of the sensing units SUa to SUd in each sensing unit group SU may be uniform as illustrated in FIG. 2.

However, referring to FIG. 1, the arrangement of the sensing units SUa to SUd included in a first sensing unit group SU may be different from the arrangement of the sensing units SUa to SUd included in a second sensing unit group adjacent to the first sensing unit group in the column direction. For example, as illustrated in FIG. 1, when the first sensing unit SUa, the second sensing unit SUb, the third sensing unit SUc, and the fourth sensing unit SUd in a first sensing unit group SU are arranged clockwise, and the first sensing unit SUa, the second sensing unit SUb, the third sensing unit SUc, and the fourth sensing unit SUd in a second sensing unit group SU adjacent to the first sensing unit group SU in the column direction may be arranged counterclockwise. Referring to FIG. 3, each of the sensing units SUa to SUd according to an exemplary embodiment of the present invention may include a switching element Qa connected with a corresponding one of the scanning signal lines Ga1 to Gan, Gb1 to Gbn, Gc1 to Gcn, and Gd1 to Gdn and a corresponding one of the sensing signal lines RO1, RO2, . . . , a sensing element Qs and a sensing capacitor Cs connected to the switching element Qa. In FIG. 3, the fourth sensing unit SUd is positioned adjacent to the first sensing unit SUa in the column direction, and the scanning signal lines Gai and Gdi (i=1, . . . , and n) are connected to the first and fourth sensing units SUa and SUd illustrated in FIG. 1.

The switching element Qa of the sensing unit SUa to SUd is a three-terminal element, such as a thin film transistor. The switching element Qa includes a control terminal connected with a corresponding one of the scanning signal lines Gai and Gdi, an output terminal connected with the sensing signal line ROj (j=1, 2, . . . ), and an input terminal connected with the sensing element Qs and the sensing capacitor Cs. The switching element Qa may transmit a sensing signal to the sensing signal line ROj according to a scanning signal of the scanning signal line Gai or Gdi and may charge the sensing capacitor Cs with a reference voltage Vf.

The sensing element Qs is a three-terminal element, such as a thin film transistor. The sensing element Qs includes an input terminal that receives a source voltage (referred to as “a first voltage”) Vs, a control terminal that receives a bias voltage (referred to as “a second voltage”) Vb, and an output terminal connected to the switching element Qa. The bias voltage Vb may be a sufficiently low or high voltage like a gate-off voltage so that the sensing element Qs may maintain the off state when light is not radiated to the sensing element Qs. The sensing element Qs may include a photoelectric material that may generate a current when irradiated with light. An example of the sensing element Qs may be a thin film transistor including amorphous silicon, amorphous silicon-germanium (A—SiGe), or a polysilicon channel that may generate current in response to light (“light current”). In the internal light IL emitted from the backlight 900, external light may also be radiated to the sensing element Qs. When the external light sensed by the sensing element Qs is infrared light, a process of removing an influence caused by the external infrared light from a sensing signal may be required. This will be described below.

Two terminals of the sensing capacitor Cs are connected to the switching element Qa and the source voltage Vs, respectively. The sensing capacitor Cs may be charged with the reference voltage Vf applied through the sensing signal line ROj as a scanning signal is applied to the switching element through the scanning signal line Gai or Gdi or the sensing capacitor Cs may be discharged as a light current flows across the sensing element Qs.

When a gate-on voltage Von is applied from a corresponding one of the scanning signal lines Ga1 to Gan, Gb1 to Gbn, Gc1 to Gcn, and Gd1 to Gdn, the switching element Qa of the sensing unit SUa or SUd is turned on. Then, the reference voltage Vf transmitted through a corresponding one of the sensing signal lines RO1, RO2, . . . is transmitted to a terminal of the sensing capacitor Cs, and the sensing capacitor Cs is charged with a voltage corresponding to a difference between the reference voltage Vf and the source voltage Vs. This step is referred to as a reset step or a reset period of the sensing units SUa to SUd.

When light is radiated to the sensing element Qs, e.g., by a touch of an external object while the switching element Qa is turn off, a light current is generated in the sensing element Qs. Then, a voltage drop occurs in the sensing capacitor Cs, and thus, the sensing capacitor Cs is discharged. When no touch was made by the external object and thus no light is radiated to the sensing element Qs, the sensing capacitor Cs is not discharged. This step is referred to as a sensing step or a sensing period of the sensing units SUa to SUd.

When the switching element Qa is turned on with the voltage charged in the sensing capacitor Cs changed due to a touch in a previous sensing step, the reference voltage Vf is recharged in the sensing capacitor Cs through the turned-on switching element Qa. In this case, a current flows through the sensing signal lines RO1, RO2, . . . , thus generating a sensing signal. The sensing signal may be input and processed in the sensing signal processing unit 800. This step is referred to as an output step or an output period. Since the reset of the sensing units SUa to SUd and the output of the sensing signal substantially simultaneously occur, the reset step may be substantially the same as the output step. Therefore, the reset step may be hereinafter referred to as a reset (output) period.

Referring back to FIGS. 1 and 2, the scan driver 400 is connected to the scanning signal lines Ga1 to Gan, Gb1 to Gbn, Gc1 to Gcn, and Gd1 to Gdn. The scan driver 400 applies a scanning signal formed of a combination of a gate-on voltage turning on the switching element Qa of each sensing unit SUa or SUd and a gate-off voltage turning off the switching element Qa of each sensing unit SUa or SUd to the scanning signal lines Ga1 to Gan, Gb1 to Gbn, Gc1 to Gcn, and Gd1 to Gdn.

The scan driver 400 may independently transmit the scanning signal to the different scanning signal line groups Ga1 to Gan, Gb1 to Gbn, Gc1 to Gcn, and Gd1 to Gdn. For example, the scan driver 400 may receive a plurality of gate clock signals CPV1, CPV2, CPV3, and CPV4 for controlling an output time of the gate-on pulse of each scanning signal line group Ga1 to Gan, Gb1 to Gbn, Gc1 to Gcn, or Gd1 to Gdn. Accordingly, the different scanning signal line groups Ga1 to Gan, Gb1 to Gbn, Gc1 to Gcn, and Gd1 to Gdn may independently transmit the gate-on voltage at different times or at the same time.

The sensing signal processing unit 800 is connected with the sensing signal lines RO1, RO2, . . . The sensing signal processing unit 800 may generate a digital sensing signal by receiving and processing the sensing signal from the sensing signal lines RO1, RO2, . . . The sensing signal processing unit 800 may generate contact information indicating whether a touch is made, the position of a touch, and the shape and size of a touched object, from the digital sensing signal.

Referring to FIG. 3, the sensing signal processing unit 800 according to an exemplary embodiment of the present invention may include an integrator INT connected to each sensing signal line ROj, a sample hold switch SWsh, a sample hold capacitor Csh, and an AD-converter ADC.

The integrator INT may include an amplifier Amp having an inversion terminal (−), a non-inversion terminal (+), and an output terminal, a capacitor Cf, and a reset switch SWr connected to the amplifier Amp The inversion terminal (−) of the amplifier Amp is connected to the sensing signal line ROj, and the capacitor Cf and the reset switch SWr are connected to the inversion terminal (−) and the output terminal. The non-inversion terminal (+) of the amplifier Amp is connected to the reference voltage Vf. The reset switch SWr is turned on at a predetermined cycle (for example, 1 H) to reset the capacitor Cf. The reset of the capacitor Cf is referred to herein as “Amp reset”.

After the Amp reset, the gate-on voltage is applied to the scanning signal lines Ga1 to Gan, Gb1 to Gbn, Gc1 to Gcn, Gd1 to Gdn, the switching element Qa of the sensing units SUa to SUd is turned on, and the sensing signal is transmitted to the sensing signal lines RO1, RO2, . . .

Then, the integrator INT, as a current integrator, integrates the current of the sensing signal from the sensing signal line ROj for a predetermined time (referred to herein as “sample hold time”) in a period between the Amp resets of the reset switch SWr charging the capacitor Cf.

When the capacitor Cf is charged for the sample hold time, the sample hold switch SWsh is turned on, so that the voltage charged in the capacitor Cf, e.g., a sensing output signal Vout, is transmitted to the sample hold capacitor Csh and the AD-converter ADC. An operation cycle of the sample hold switch SWsh may also be about 1 horizontal cycle (“H”). The sample hold time may be adjusted.

The AD-converter ADC may generate a digital sensing signal by analog-to-digital (AD) converting the sensing output signal Vout.

Returning to FIGS. 1 and 2, the backlight 900 generates the internal light IL, such as infrared light and visible light. The backlight 900 is positioned at a rear surface of the display device. The backlight 900 may radiate the generated internal light IL to the plurality of sensing units SUa to SUd. For example, the backlight 900 according to an exemplary embodiment of the present invention may generate infrared light for sensing a touch of an external object. In this case, when the external object approaches the display panel 300 of the display device, the infrared light emitted from the backlight 900 is reflected from the external object to the sensing unit SUa to SUd. In a case where the backlight 900 generates visible light for sensing an image of an external object, when the external object approaches the display panel 300, visible light emitted from the backlight 900 may be reflected from the approaching external object to the sensing units SUa to SUd.

The sensing units SUa to SUd according to an exemplary embodiment of the present invention may sense a type of light. For example, the plurality of sensing units

SUa to SUd may sense light of different wavelength bands. For example, a display device may include infrared light sensing units for sensing infrared light and visible light sensing units for sensing visible light. In this case, the infrared light sensing units and the visible light sensing units may be alternately arranged.

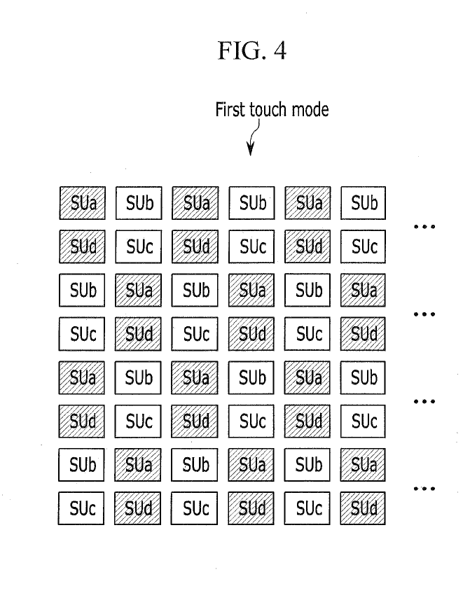

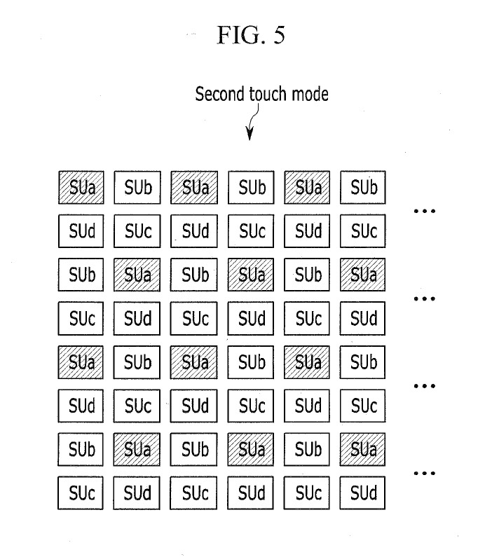

FIGS. 4 and 5 are layout views illustrating a light sensor in a display device according to an exemplary embodiment of the present invention. The light sensor operates in first and second touch modes.

Referring to FIG. 4, in the first touch mode, at least two sensing units (e.g., SUa and SUd) among the plurality of sensing units SUa to SUd substantially simultaneously perform a sensing operation to output sensing signals. Accordingly, the touch sensitivity of the display device may be increased. Referring to FIG. 4, at least two sensing units SUa to SUd substantially simultaneously performing the sensing operation may be positioned adjacent to each other and are connected to substantially the same sensing signal line RO1, RO2, . . . FIG. 4 illustrates an example in which, in the sensing unit arrangement shown in FIG. 2, the first sensing unit SUa and the fourth sensing unit SUd adjacent to the first sensing unit SUa in the column direction together performs the sensing operation to obtain contact information.

Referring to FIG. 5, the plurality of sensing units SUa to SUd perform the sensing operation at different times from each other in the second touch mode. For example, only one sensing unit SUa to SUd among the plurality of sensing units SUa to SUd may perform a sensing operation to obtain contact information. To obtain high-resolution contact information, at least two sensing units SUa to SUd may be sequentially operated according to a frame. FIG. 5 illustrates an example in which, in the sensing unit arrangement shown in FIG. 2, only the first sensing unit SUa performs a sensing operation to obtain contact information .

A sample hold time in the first touch mode and a sample hold time in the second touch mode may be substantially the same or different from each other.

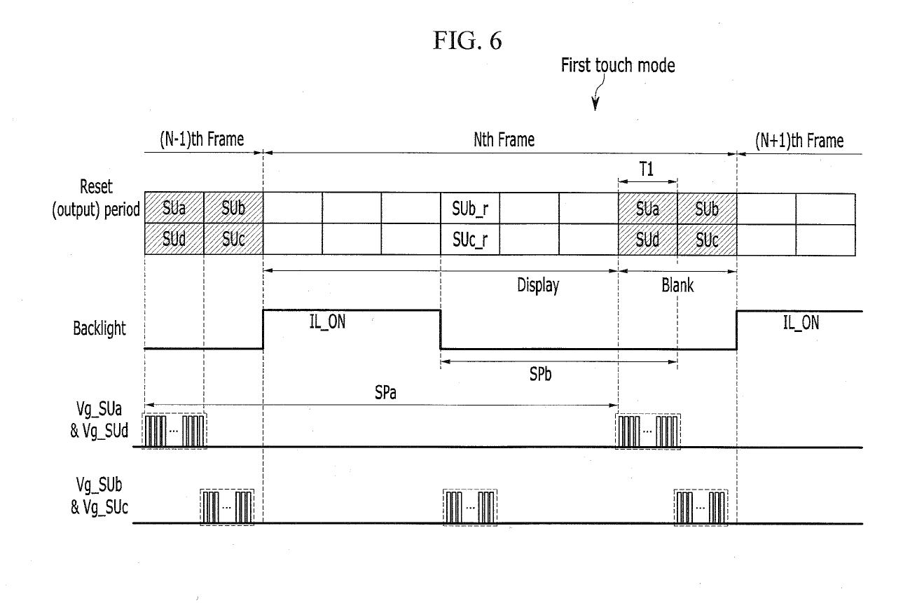

FIGS. 6, 7, 8, and 9 are timing diagrams illustrating a method of driving a display device including a light sensor according to an exemplary embodiment of the present invention.

Reset periods or output periods of the sensing units SUa to SUd illustrated in FIGS. 6 to 9 are denoted with substantially the same reference characters as the sensing units SUa to SUd, and are also referred to as reset (output) periods. A continuous time T1 of each reset (output) period may be substantially the same as a time to sequentially apply the gate-on voltage to the scanning signal lines Ga1 to Gan, Gb1 to Gbn, Gc1 to Gcn, and Gd1 to Gdn connected to the respective sensing units SUa to SUd. However, the continuous time T1 is not limited thereto, and may be longer than the time to sequentially apply the gate-on voltage to the scanning signal lines.

Referring to FIGS. 6 to 9, the backlight 900 radiates the internal light IL to the display device for a light irradiation period IL_ON in a cycle of one frame. A time from a start point of one light irradiation period IL_ON to a start point of a next light irradiation period IL_ON corresponds to one frame, and a period between the light irradiation periods IL_ON adjacent to each other is referred to as a light non-irradiation period. FIG. 6 illustrates an N^{th} frame, and N−1^{th} and N+1^{th} frames respectively positioned before and after the N^{th} frame.

When the backlight 900 supplies visible light for displaying an image and the internal light IL to the display panel 300 of the display device, one frame may also be an image display cycle. One image display cycle may include a display period during which an image data signal is input to the display panel 300 and a blank period during which no image data signal is input to the display panel 300.

In the display period, image data voltages may be applied to the pixels by sequentially applying the gate-on voltages to the image scanning signal lines. The start point of the light irradiation period IL_ON may correspond to a start point of the display period.

The blank period is positioned between the display periods adjacent to each other. In the blank period, an image input during a previous display period may be maintained.

The reset (output) period for outputting the sensing signal may be positioned in the blank period.

FIG. 6 illustrates one example of a sensing operation according to a first touch mode.

In FIG. 6, as an example, the first sensing unit SUa and the fourth sensing unit SUd adjacent to the first sensing unit SUa substantially simultaneously perform the sensing operation. For example, a scanning signal Vg_SUa input to the first sensing unit SUa and a scanning signal Vg_SUd input to the fourth sensing unit SUd may be synchronized with each other. In this case, the gate clock signal CPV1 for outputting the scanning signal Vg_SUa and the gate clock signal CPV4 for outputting the scanning signal Vg_SUd may be synchronized with each other.

The first sensing unit SUa and the fourth sensing unit SUd for obtaining contact information may be reset (output) once for every frame generating the sensing signals. The reset (output) periods SUa and SUd of the first sensing unit SUa and the fourth sensing unit SUd are positioned between light irradiation periods IL_ON adjacent to each other and do not overlap the light irradiation periods IL_ON.

A period between the reset (output) periods SUa and SUd adjacent to each other of the first sensing unit SUa and fourth sensing unit SUd adjacent to each other is a sensing period SPa. The sensing period SPa illustrated in FIG. 6 may be the sensing period SPa for the first sensing unit SUa and the fourth sensing SUd connected to the scanning signal line Ga1 and Gd1 first receiving the gate-on voltage. One sensing period SPa may last for about one frame.

The light irradiation period IL_ON of the backlight 900 is positioned within one sensing period SPa. The sensing period SPa may include the light irradiation period IL_ON and the light non-irradiation period after the light irradiation period IL_ON. External light may be radiated to the first sensing unit SUa and the fourth sensing unit SUd without the internal light IL being radiated during the light non-irradiation period of the sensing period SPa.

After the sensing period Spa has ended, the sensing capacitor Cs is recharged with the reference voltage Vf during the reset (output) periods SUa and SUd of the first sensing unit SUa and the fourth sensing unit SUd, and a sensing signal is substantially simultaneously generated according to the voltage of the sensing capacitor Cs changed during the sensing period SPa.

When at least two different sensing units SUa to SUd connected to substantially the same sensing signal line RO1, RO2, . . . are substantially simultaneously subjected to a sensing operation, a larger sensing output signal Vout may be obtained compared to a sensing output signal obtained when one sensing unit SUa to SUd is subjected to a sensing operation. Accordingly, accurate contact information may be obtained from a large sensing output signal Vout regardless of external noise.

Noise may be generated in the sensing signal due to an influence of external light, other than the internal light IL emitted from the backlight 900, during the sensing period SPa of the first sensing unit SUa and the fourth sensing unit SUd. To remove the noise, another sensing unit may be positioned adjacent to or near the first sensing unit SUa and the fourth sensing unit SUd.

In FIG. 6, as an example, noise caused by external light is removed by using the second sensing unit SUb and the third sensing unit SUc adjacent to the first sensing unit SUa and the fourth sensing unit SUd, respectively.

The second sensing unit SUb and the third sensing unit SUc for removing the noise generated by the external light may be reset (output) at least two times during one frame.

For example, after the light irradiation period IL_ON has ended, at least one reset (output) period SUb_r and SUc_r of the second sensing unit SUb and the third sensing unit SUc may be positioned in the sensing period SPa of the first sensing unit SUa and the fourth sensing unit SUd. A scanning signal Vg_SUb input to the second sensing unit SUb and a scanning signal Vg_SUc input to the third sensing unit SUc may be synchronized with each other in the reset (output) periods SUb_r and SUc_R of the second sensing unit SUb and the third sensing unit SUc. At least one of the reset (output) periods SUb_r and SUc_r of the second sensing unit SUb and the third sensing unit SUc may not overlap the light irradiation period IL_ON.

The second sensing unit SUb and the third sensing unit SUc may output the sensing signal by the external light in the next reset (output) periods SUb and SUc by receiving the external light during a sensing period SPb after the reset (output) period Sub_r and SUc_r included in the sensing period SPa of the first sensing unit SUa and the fourth sensing unit SUd ends and before next reset (output) periods SUb and SUc start. The sensing period SPb illustrated in FIG. 6 is the sensing period SPb for the second sensing unit SUb and the third sensing unit SUc connected to the scanning signal lines Gb1 and Gc1 first receiving the gate-on voltage. The next reset (output) periods SUb and SUc of the second sensing unit SUb and the third sensing unit SUc are the periods for obtaining the sensing signal. The next reset (output) periods Sub and SUc of the second sensing unit Sub and the third sensing unit SUc may be positioned in the blank period and may be adjacent to the reset (output) periods SUa and SUd of the first sensing unit SUa and the fourth sensing unit SUd.

Accordingly, by subtracting the sensing signals of the second sensing unit SUb and the third sensing unit SUc from the sensing signals of the first sensing unit SUa and the fourth sensing unit SUd in the N^{th} frame, the influence of the external light may be removed from the sensing signals of the first sensing unit SUa and the fourth sensing unit SUd, thereby removing noise.

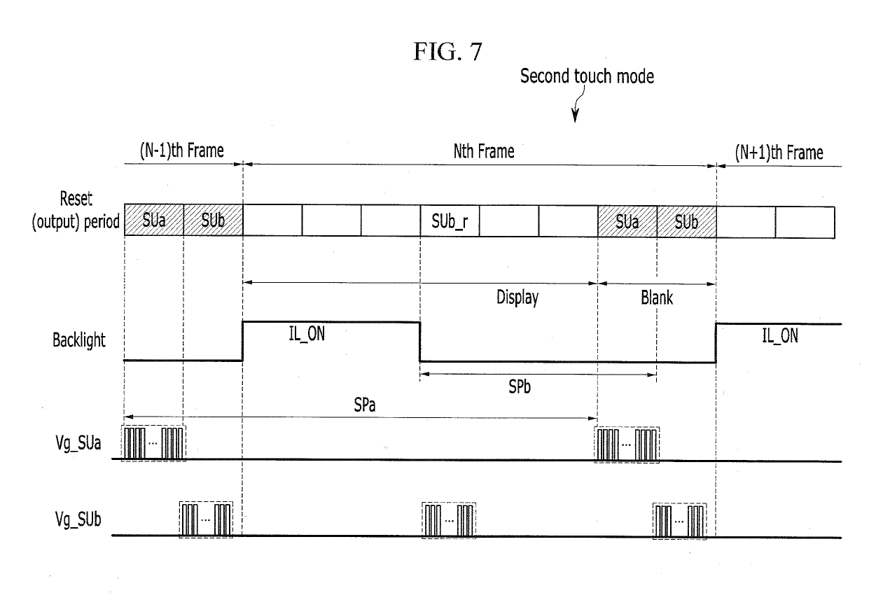

FIG. 7 illustrates an example of a sensing operation according to a second touch mode.

Referring to FIG. 7, for example, only the first sensing unit SUa performs the sensing operation to output the sensing signal, and the remaining sensing units do not perform the sensing operation simultaneously with the first sensing unit SUa. For example, while the scanning signal Vg_SUa input to the first sensing unit SUa is scanned, the scanning signals of other sensing units are not scanned. The first sensing unit SUa may be operated as described above in connection with FIG. 6.

To remove an influence of the external light from the sensing signal of the first sensing unit SUa, another sensing unit, e.g., the second sensing unit SUb, adjacent to or near the first sensing unit SUa, may be used. In this case, substantially the same noise removing method described above in connection with FIG. 6 may be used.

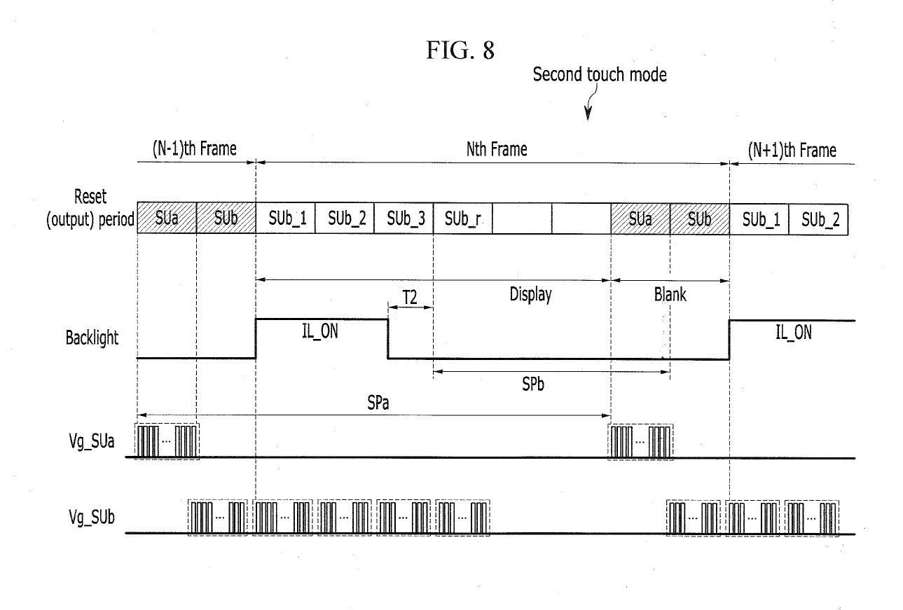

FIG. 8 illustrates an example of a sensing operation according to the second touch mode.

This sensing operation may be substantially the same as the sensing operation described above in connection with FIG. 7, except for an operation of the second sensing unit SUb for removing a noise caused by the external light.

The second sensing unit Sub may be reset (output) at least three times during one frame. For example, the second sensing unit SUb may further include at least one additional reset period SUb_{—}1, SUb_{—}2, and SUb_{—}3, other than the reset (output) period SUb and SUb_r described above in connection with FIG. 7. In FIG. 8, as an example, the second sensing unit SUb is additionally reset in the three additional reset periods SUb_{—}1, SUb_{—}2, and SUb_{—}3. The sensing signal is generated in the additional reset periods SUb_{—}1, SUb_{—}2, SUb_{—}3. However, the contact information is not obtained from the sensing signal processing unit 800, and the sensing capacitor Cs is charged with the reference voltage Vf to reset the second sensing unit SUb. The additional reset periods SUb_{—}1, SUb_{—}2, and SUb_{—}3 of the second sensing unit SUb may overlap or may not overlap the light irradiation period IL_ON.

Since the second sensing unit SUb for removing a noise caused by the external light is reset several times during at least two reset (output) periods SUb_r, SUb_{—}1, SUb_{—}2, and SUb_{—}3 positioned in the sensing period SPa of the first sensing unit SUa, the sensing capacitor Cs may be charged with the reference voltage Vf, and charges, which may be left in the sensing element Qs, may be removed.

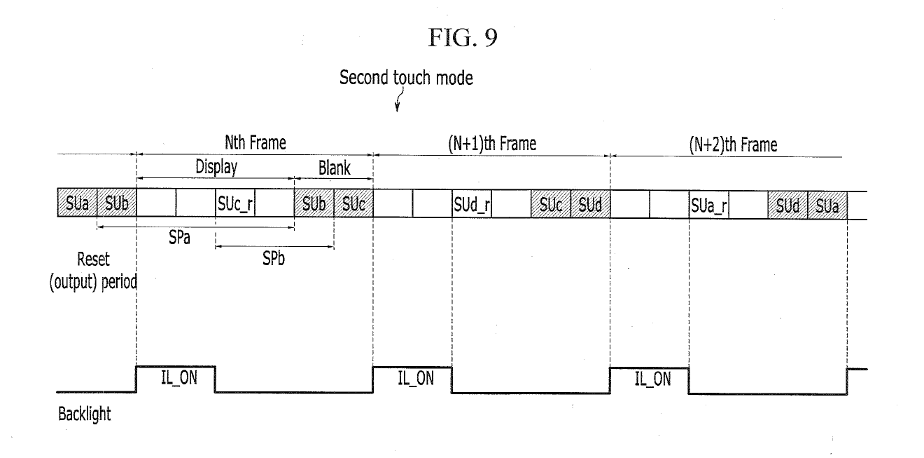

FIG. 9 illustrates an example of a sensing operation performed in the second touch mode.

This sensing operation is substantially the same as the sensing operation described above in connection with FIG. 7, except that two or more sensing units SUa to SUd may obtain the contact information by alternately performing the sensing operation during a plurality of frames. In FIG. 9, as an example, all of the sensing units SUa to SUd alternately perform the sensing operation. For example, the first sensing unit SUa may output the sensing signal during the sensing period SPa of the N−1^{th} frame, the second sensing unit SUb outputs the sensing signal during the sensing period SPa of the N^{th} frame, the third sensing unit SUc may output the sensing signal during the sensing period SPa of the N+1^{th} frame, and the fourth sensing unit SUd may output the sensing signal during the sensing period SPa of the N+2^{th} frame.

In this case, noise caused by the external light may be removed from the contact information through the sensing units SUa to SUd that are reset (output) at least two times every frame as described above in connection with FIG. 7. For example, when the contact information is obtained from the sensing signal of the second sensing unit SUb as illustrated in FIG. 9, the sensing signal caused by the external light may be output during the reset (output) period SUc of the blank period after resetting the third sensing unit SUc in the reset (output) period Suc_r directly after the light irradiation period IL_ON. Likewise, when the contact information is obtained from the sensing signal of the third sensing unit SUc, the sensing signal caused by the external light may be output during the reset (output) period SUd of the blank period after resetting the fourth sensing unit SUd in the reset (output) period SUd_r directly after the light irradiation period IL_ON.

As described above, high-resolution contact information may be obtained by outputting the sensing signal by using two or more sensing units SUa to SUd. For example, by the sensing operation described above in connection with FIG. 9, the contact information having a resolution about four times higher as compared to the sensing operation described above in connection with FIG. 7 may be obtained.

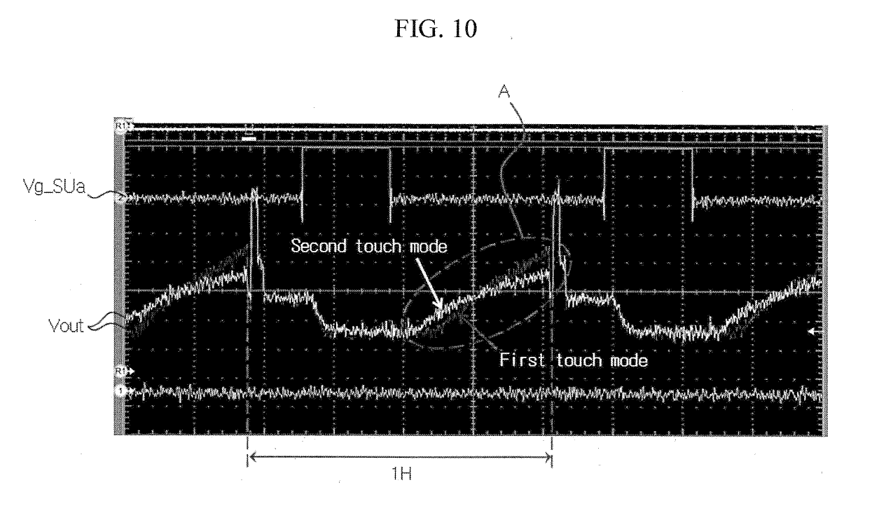

FIG. 10 is a waveform diagram illustrating a sensing output signal according to a method of driving a display device including a light sensor according to an exemplary embodiment of the present invention.

FIG. 10 illustrates waveforms of the scanning signal Vg_SUa and the sensing output signal Vout for the first sensing unit SUa among the sensing units SUa to SUd in the first touch mode and the second touch mode. When the scanning signal Vg_SUa is changed to a high level, the switching element Qa of the sensing unit SUa to SUd is turned on, so that the sensing capacitor Cs is charged. In this case, the sensing output signal Vout may be dropped due to a kick-back voltage caused by a parasitic capacitance between the input terminal and the output terminal and the control terminal of the switching element Qa. In FIG. 10, a dropping portion of the sensing output signal

Vout is shown as partially cut. In the first mode, more switching elements Qa are connected to one sensing signal line RO1, RO2 as compared with the second touch mode, and thus, the kick-back voltage is also increased in the first mode compared with the second touch mode. Accordingly, as illustrated in FIG. 10, the sensing output signal Vout in the first touch mode may be lower than the sensing output signal Vout in the second touch mode when the switching element Qa is turned on or during a predetermined period after the switching element Qa is turned on.

Then, the sensing output signal Vout is increased as illustrated in portion “A” of FIG. 10 as the capacitor Cf of the integrator NT is charged with the sensing signal In this case, since an increase rate of the sensing output signal Vout in the first touch mode is larger than an increase rate of the sensing output signal Vout in the second touch mode, the sensing output signal Vout in the first touch mode is larger than the sensing output signal Vout in the second touch mode after the sample hold time elapses, thus providing a higher touch sensitivity. Accordingly, the sensing output signal Vout may be increased in the second touch mode by increasing the sufficient sample hold time.

For example, according to an exemplary embodiment of the present invention, the touch sensitivity may be increased by making the sample hold time in the first touch mode longer than the sample hold time in the second touch mode. For example, the sample hold time in the first touch mode may be about 1.3 times to about 2 times longer than the sample hold time in the second touch mode. For example, the sample hold time in the second touch mode may be about 1.3 times to about 2 times longer than a time during which the gate clock signals CPV1, CPV2, CPV3, and CPV4 are in the high state. The sample hold time in the first touch mode may be increased as long as possible within one horizontal cycle 1 H.

According to an exemplary embodiment of the present invention, the sample hold time in the first touch mode may be substantially the same as the sample hold time in the second touch mode. In this case, however, an offset may be generated in the sensing output signal Vout in the second touch mode, and thus, the digital sensing signal may be relatively high or relatively low. To compensate for the offset of the sensing output signal Vout, the reference voltage of the AD-converter ADC in the sensing signal processing unit 800 may be changed considering a contact threshold voltage Vth. The contact threshold voltage Vth may be a threshold voltage or a reference voltage for determining whether there is a touch of an external object. For example, it may be determined that there is a touch of the external object when a voltage of the sensing output signal Vout is substantially equal to or higher than the contact threshold voltage Vth. According to an exemplary embodiment of the present invention, a value of the digital sensing signal generated in the AD-converter ADC for compensating for the offset of the sensing output signal Vout may be adjusted or changed.

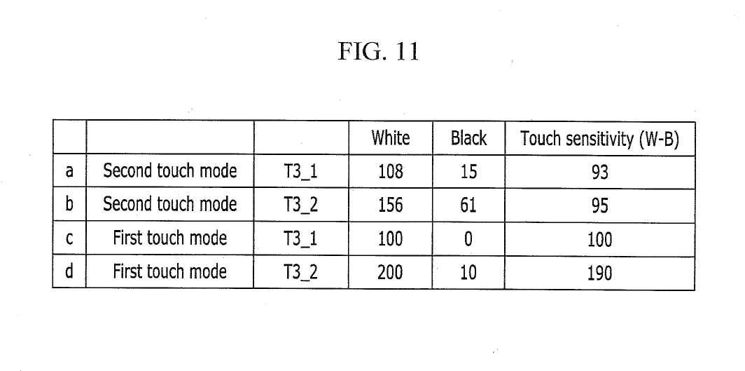

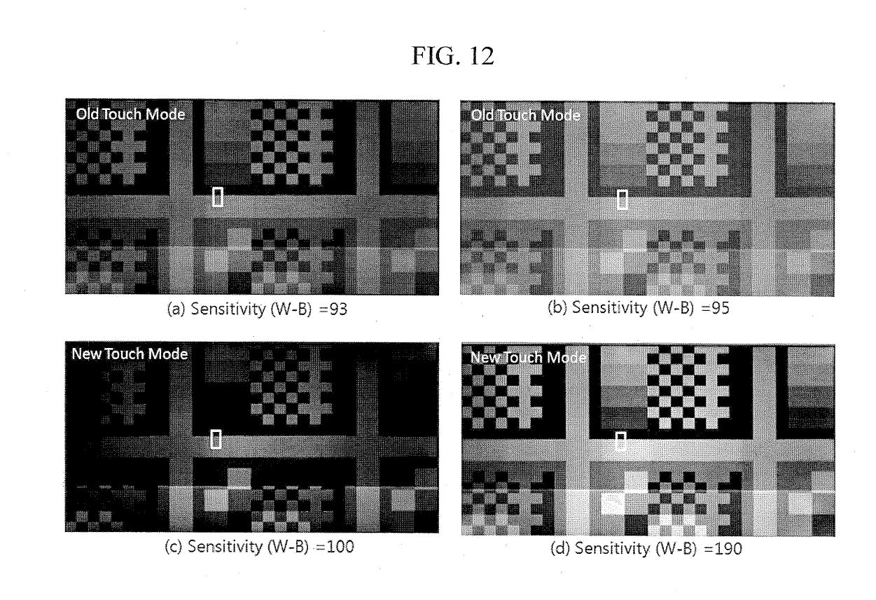

FIG. 11 is a table showing touch sensitivities that may be obtained when a display device including a light sensor is in the first and second touch modes according to an exemplary embodiment of the present invention, and FIG. 12 shows photographs illustrating sensitivities that may be measured with respect to the four cases illustrated in FIG. 11.

The touch sensitivity of the display device according to an exemplary embodiment of the present invention may be defined as a difference between a sensing output signal or a digital sensing signal generated when a white object that reflects light, touches the display device and a sensing output signal or a digital sensing signal generated when a black object that absorbs light, touches the display device.

Referring to FIGS. 11 and 12, when the display device according to an exemplary embodiment of the present invention is operated in the second touch mode, a touch sensitivity W-B obtained at a first time T3_1 during which the sample hold time is relatively short is about 93, and a touch sensitivity W-B obtained at a second time T3_2 during which the sample hold time is longer than the first time T3_1 is about 95. When the display device is operated in the first touch mode, a touch sensitivity W-B obtained at the first time T3_1 during which the sample hold time is relatively short is about 100, and a touch sensitivity W-B obtained at the second time T3_2 during which the sample hold time is longer than the first time T3_1 is about 190. As such, when the display device operates in the first touch mode, as the sample hold time is increased, the touch sensitivity is noticeably increased.

As illustrated in FIGS. 11 and 12, as the sample hold time is increased, the overall values of the sensing output signals or digital sensing signal may be increased. In this case, the accurate contact information or contact image may be generated by adjusting the reference voltage of the AD-converter ACD or the digital sensing signal to thereby compensate for the offset of the sensing output signal Vout.

While exemplary embodiments of the invention have been described, it is to be understood that the invention is not limited to the exemplary embodiments, and various modifications and variations may be made thereto.

What is claimed is:

1. A method of driving a display device, the method comprising:
applying scanning signals to a plurality of sensing units of a first sensing unit group among a plurality of sensing unit groups; and
generating sensing signals from the plurality of sensing units of the first sensing unit group and outputting the generated sensing signals to at least one sensing signal line,
wherein, the scanning signals applied to two or more sensing units among the plurality of sensing units of the first sensing unit group are synchronized with each other in a first touch mode.

2. The method of claim 1, wherein:
scanning periods of the scanning signals applied to the plurality of sensing units of the first sensing unit group do not overlap each other in a second touch mode, which is different from the first touch mode.

3. The method of claim 2, wherein the two or more sensing units output the sensing signals to a common sensing signal line.

4. The method of claim 3, wherein output of the scanning signals is controlled by a plurality of different gate clock signals.

5. The method of claim 4, wherein each of the plurality of sensing units of the first sensing unit group comprises:
a switching element connected to a scanning signal line and the sensing signal line; and
a sensing element and a sensing capacitor connected with the switching element, wherein the display device comprises a sensing signal processing unit, the sensing signal processing unit comprising:
an integrator connected to the sensing signal line; and
a capacitor connected between an output terminal and an input terminal of an integrator, and wherein
the capacitor is charged with a sensing signal for a sample hold time, and the output terminal of an integrator outputs a sensing output signal.

6. The method of claim 5, wherein the sample hold time in the first touch mode is different from the sample hold time in the second touch mode.

7. The method of claim 5, wherein the sample hold time in the first touch mode is substantially the same as the sample hold time in the second touch mode.

8. The method of claim 7, further comprising:
converting the sensing output signal into a digital sensing signal; and
adjusting at least one value of a reference voltage used for the converting or the digital sensing signal in the second touch mode.

9. The method of claim 5, further comprising:
radiating internal light to the plurality of sensing unit groups during a light irradiation period repeated at a cycle of one frame; and
outputting a sensing signal by external light by resetting, at least two times during one frame, at least one sensing unit, except for the two or more sensing units, among the plurality of sensing units in the first sensing unit group.

10. The method of claim 9, further comprising:
sequentially outputting the sensing signal alternatively by the plurality of sensing units of the first sensing unit group in the second touch mode.

11. A display device, comprising:
a plurality of sensing unit groups arranged in a matrix form, each of the plurality of sensing unit groups comprising a plurality of sensing units;
a plurality of scanning signal lines respectively connected with a plurality of sensing units of a first sensing unit group among the plurality of sensing unit groups;
at least one sensing signal line connected with the plurality of sensing units of the first sensing unit group;
a scanning driver configured to transmit scanning signals to the plurality of scanning signal lines, respectively; and
a sensing signal processing unit configured to process a sensing signal transmitted through the sensing signal line,
wherein the scanning signals applied to two or more sensing units among the plurality of sensing units of the first sensing unit group are synchronized with each other in a first touch mode.

12. The display device of claim 11, wherein scanning periods of the scanning signals applied to the plurality of sensing units of the first sensing unit group do not overlap each other in a second touch mode, which is different from the first touch mode.

13. The display device of claim 12, wherein the two or more sensing units are connected to substantially the same sensing signal line.

14. The display device of claim 13, wherein the scanning signals transmitted through the plurality of scanning signal lines are output under control of different gate clock signals from each other.

15. The display device of claim 14, wherein each of the plurality of sensing units comprises:
a switching element connected to a corresponding one of the plurality of scanning signal lines and the sensing signal line; and
a sensing element and a sensing capacitor that are connected with the switching element,
wherein the sensing signal processing unit comprises:
an integrator connected to the sensing signal line; and
a capacitor connected between an output terminal and an input terminal of the integrator, and
wherein the capacitor is charged with a sensing signal for a sample hold time, and the output terminal of the integrator outputs a sensing output signal.

16. The display device of claim 15, wherein the sample hold time in the first touch mode is different from the sample hold time in the second touch mode.

17. The display device of claim 15, wherein the sample hold time in the first touch mode is substantially the same as the sample hold time in the second touch mode.

18. The display device of claim 17, wherein the sensing signal processing unit further comprises an analog-digital (AD) converter configured to convert the sensing output signal into a digital sensing signal, and wherein
at least one value of a reference voltage of the AD converter or the digital sensing signal is adjusted in the second touch mode.

19. The display device of claim 15, further comprising:
a backlight configured to radiate internal light to the plurality of sensing unit groups during a light irradiation period repeated at a cycle of one frame,
wherein at least one sensing unit, except for the two or more sensing units, among the plurality of sensing units of the first sensing unit group is reset at least two times during one frame to output a sensing signal by external light.

20. The display device of claim 19, wherein the plurality of sensing units of the first sensing unit group sequentially and alternately outputs the sensing signals in the second touch mode.

21. A display device comprising:
a first sensing unit;
a second sensing unit positioned adjacent to the first sensing unit;
a first scanning line connected to the first sensing unit, wherein a first scanning signal is applied through the first scanning line to the first sensing unit;
a second scanning line connected to the second sensing unit, wherein a second scanning signal is applied through the second scanning line to the second sensing unit; and
a sensing line jointly connected to the first sensing unit and the second sensing unit, wherein in a first touch mode, the first scanning signal is synchronized with the second scanning signal.
